(19) United States
(12) Patent Application Publication
(10) Pub. No.: US 2024/0155210 A1
(43) Pub. Date: May 9, 2024

(54) DATA GENERATION APPARATUS AND CONTROL METHOD

(71) Applicant: CANON KABUSHIKI KAISHA, Tokyo (JP)

(72) Inventor: Yukihiro KOGAI, Kanagawa (JP)

(21) Appl. No.: 18/491,843

(22) Filed: Oct. 23, 2023

(30) Foreign Application Priority Data
Nov. 8, 2022 (JP) 2022-179090

(51) Int. Cl. H04N 23/11; G06T 5/00; G06V 10/60

(52) U.S. Cl. CPC H04N 23/11; G06T 5/002; G06V 10/60; G06V 2201/07

(57) ABSTRACT

A data generation apparatus comprises a first image acquiring unit that acquires a visible light image, a second image acquiring unit that acquires an invisible light image, a subject detection unit that detects a subject in the visible light image, and a supervisory data generation unit that generates supervisory data to be used in learning of a learning model for subject detection of an invisible light image based on the invisible light image and a subject detection result acquired by the subject detection unit.

### BACKGROUND OF THE INVENTION

### Field of the Invention

The present invention relates to techniques for generating supervisory data to be used in learning of a learning model for subject detection processing of an invisible light image.

### Description of the Related Art

A method in which, in an image capture apparatus, such as a digital camera, a subject is detected in an image by image analysis processing or image recognition processing in which a learning model for which learning processing has been performed by machine learning is used is known. Further, Japanese Patent Laid-Open No. 2019-118043 discloses a method of performing subject detection processing of a visible light image and an invisible light image using machine learning.

A large amount of supervisory data is necessary for learning processing of a learning model for subject detection processing of visible light images; conventionally, learning models for visible light images are the mainstream of learning models for subject detection processing; it takes a lot of effort and man-hours to generate a large amount of supervisory data to be used in machine learning of a learning model for subject detection of an invisible light image.

### SUMMARY OF THE INVENTION

The present invention has been made in consideration of the aforementioned problems and realizes techniques for allowing efficient and accurate generation of supervisory data to be used in learning of a learning model for detecting a subject in an invisible light image.

In order to solve the aforementioned problems, the present invention provides a data generation apparatus comprising: a first image acquiring unit that acquires a visible light image; a second image acquiring unit that acquires an invisible light image; a subject detection unit that detects a subject in the visible light image; and a supervisory data generation unit that generates supervisory data to be used in learning of a learning model for subject detection of an invisible light image based on the invisible light image and a subject detection result acquired by the subject detection unit.

In order to solve the aforementioned problems, the present invention provides a method of controlling a data generation apparatus, the method comprising: acquiring a visible light image and an invisible light image; detecting a subject in the visible light image; and generating supervisory data to be used in learning of a learning model for subject detection of an invisible light image based on the invisible light image and the subject detection result.

In order to solve the aforementioned problems, the present invention provides a non-transitory computer-readable storage medium storing a program for causing a computer to function as a data generation apparatus comprising: a first image acquiring unit that acquires a visible light image; a second image acquiring unit that acquires an invisible light image; a subject detection unit that detects a subject in the visible light image; and a supervisory data generation unit that generates supervisory data to be used in learning of a learning model for subject detection of an invisible light image based on the invisible light image and a subject detection result acquired by the subject detection unit.

According to the present invention, supervisory data to be used in learning of a learning model for subject detection of an invisible light image can be efficiently and accurately generated.

Further features of the present invention will become apparent from the following description of exemplary embodiments (with reference to the attached drawings).

### BRIEF DESCRIPTION OF THE DRAWINGS

FIG. 1 is a block diagram illustrating an apparatus configuration according to a first embodiment.

FIG. 2 is a diagram illustrating a relationship among a visible light image, an invisible light image, and a detection result of a subject detected in the visible light image according to the first embodiment.

FIG. 3 is a diagram illustrating image processing for generating supervisory data to be used in machine learning of a learning model for subject detection of an invisible light image according to the first embodiment.

FIG. 4 is a diagram illustrating an example of display of a visible light image, an invisible light image, and a subject detection result according to the first embodiment.

FIG. 5 is a diagram illustrating an example of display of a generation result of supervisory data to be used in machine learning of a learning model for subject detection of an invisible light image according to the first embodiment.

FIG. 6 is a flowchart exemplifying processing for generating supervisory data to be used in machine learning of a learning model for subject detection of an invisible light image according to the first embodiment.

FIG. 7 is a diagram of a system configuration according to a second embodiment.

FIG. 8 is a flowchart exemplifying processing for generating supervisory data to be used in machine learning of a learning model for subject detection of an invisible light image according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

An example in which a data generation apparatus has been applied to an image capture apparatus, such as a digital camera, will be described below.

An image capture apparatus 100 of the first embodiment captures a visible light image and an invisible light image and generates supervisory data for a learning model for subject detection processing of an invisible light image based on the invisible light image and a subject detection result (type, position, and size of the subject) of the visible light image. The supervisory data of the present embodiment is data to be used in machine learning of a learning model for subject detection of an invisible light image, and learning processing is executed with supervisory data as input data (an invisible light image) and output data (a detection result of a subject detected from a visible light image).

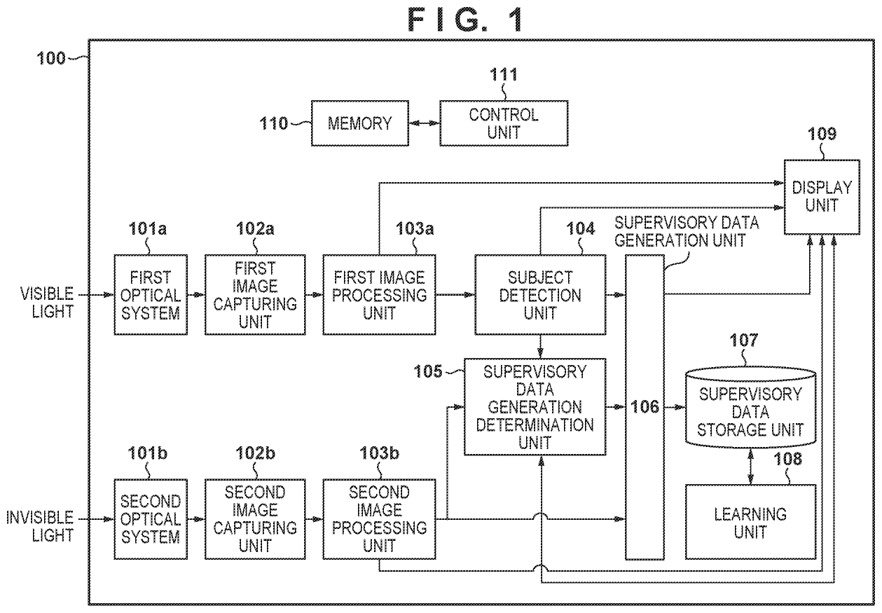

FIG. 1 is a block diagram illustrating a configuration of the image capture apparatus 100 according to the first embodiment.

The image capture apparatus 100 includes a first optical system 101a, a second optical system 101b, a first image capturing unit 102a, a second image capturing unit 102b, a first image processing unit 103a, a second image processing unit 103b, a subject detection unit 104, a supervisory data generation determination unit 105, a supervisory data generation unit 106, a supervisory data storage unit 107, a learning unit 108, a display unit 109, a memory 110, and a control unit 111.

The first optical system 101a includes one or more lenses and forms an image of subject image light in a visible light range on the first image capturing unit 102a. The second optical system 101b includes one or more lenses and forms an image of subject image light in an invisible light range on the second image capturing unit 102b. An image in a visible light range is, for example, an image in a wavelength range of 400 to 800 nm. An image in an invisible light range is, for example, a near-infrared image in a near-infrared wavelength range of 800 to 2500 nm but may be a far-infrared image in a far-infrared wavelength range of 4 μm to 1000 μm or an ultraviolet image in an ultraviolet wavelength range of 380 nm or less.

The first image capturing unit 102a includes an image sensor, such as a CMOS sensor, for converting subject image light of a visible light range formed into an image by the first optical system 101a into an electric signal. The image sensor includes, for example, color filters in an RGB Bayer array. The first image capturing unit 102a includes an AD converter for converting an analog electric signal into a digital signal.

The second image capturing unit 102b includes an image sensor, such as a CMOS, for converting subject image light of an invisible light range formed into an image by the second optical system 101b into an electric signal. The image sensor includes, for example, a color filter that passes light of a near-infrared wavelength range. The second image capturing unit 102b includes an AD converter for converting an analog electric signal into a digital signal.

The first image processing unit 103a includes a processor (GPU) for executing predetermined image processing on a digital signal obtained by the first image capturing unit 102a and generates visible light image data. The predetermined image processing includes, for example, distortion correction processing, noise removal processing, exposure correction processing, white balance processing, and edge enhancement processing.

The second image processing unit 103b includes a processor (GPU) for executing predetermined image processing on a digital signal obtained by the second image capturing unit 102b and generates invisible light image data. The predetermined image processing includes, for example, distortion correction processing, noise removal processing, exposure correction processing, white balance processing, and edge enhancement processing.

The subject detection unit 104 detects one or more subjects in a visible light image processed by the first image processing unit 103a. Then, the subject detection unit 104 detects class information indicating the type of the detected subject, position information indicating a position (center coordinates) of the subject, size information indicating a size of the subject, and the like. Subject detection can be realized by image analysis processing or image recognition processing in which a learning model for which learning processing has been performed by machine learning is used. A learning model is, for example, a neural network, and the class information (such as whether a person is included or a car is included), the position information, and the size information of a subject in an image is detected using a learning model trained with supervisory data.

Here, processing for generating supervisory data to be used in machine learning of a learning model for subject detection of an invisible light image (hereinafter, abbreviated to invisible light image supervisory data) and processing for learning the learning model using the invisible light image supervisory data of the present embodiment will be described.

The invisible light image supervisory data of the present embodiment is generated based on an invisible light image and the class information, the position information, and the size information of a subject obtained from a visible light image.

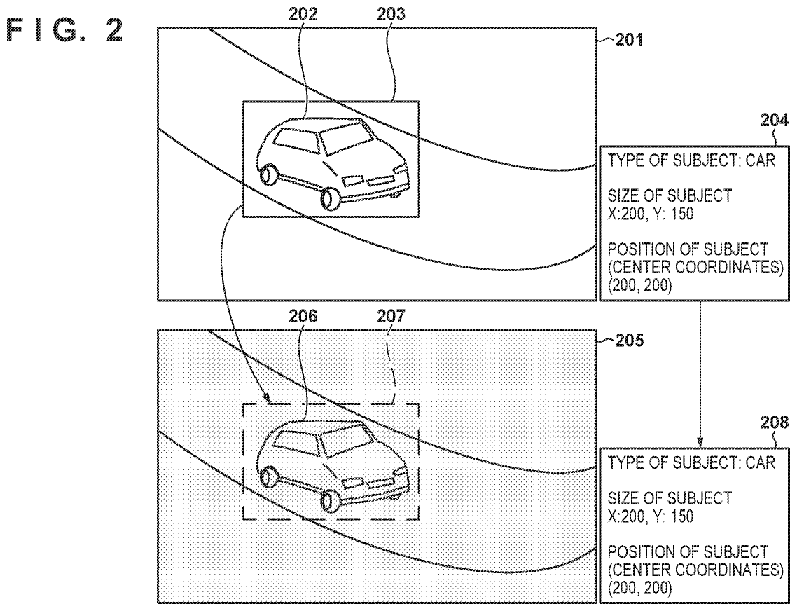

FIG. 2 is a diagram illustrating a relationship among a visible light image, an invisible light image, and a detection result of a subject detected in the visible light image according to the present embodiment. In the example of FIG. 2, a visible light image 201 is an image that has been processed by the first image processing unit 103a, and the subject detection unit 104 detects a subject 202 for which a subject region 203 has been surrounded by a rectangular frame. A subject detection result 204 includes the class information, the size information (X, Y), and the position information (center coordinates) of the subject.

An invisible light image 205 is an image that has been processed by the second image processing unit 103b and is an image that has been captured at the same angle of view as that of the visible light image 201. A subject 206 is a subject that corresponds to the subject 202 of the visible light image 201. A subject region 207 and a subject detection result 208 are the same as the subject region 203 and the subject detection result 204 of the visible light image.

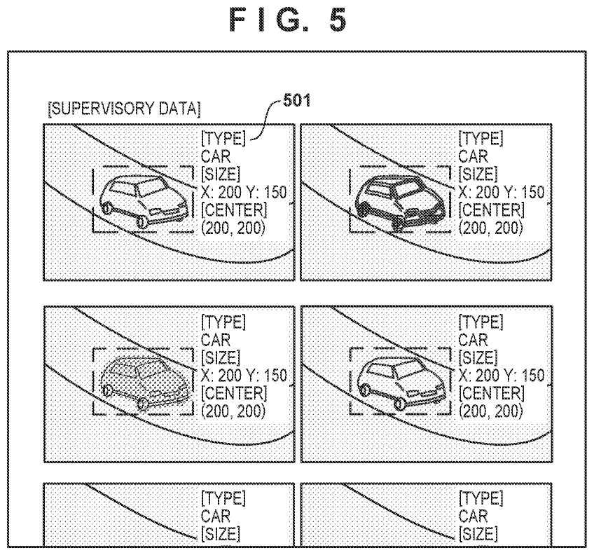

The supervisory data generation determination unit 105 determines whether invisible light image supervisory data can be generated based on a subject detection result obtained by the subject detection unit 104 and an invisible light image obtained by the second image processing unit 103b. Regarding a determination method, for example, a histogram of luminance values of an invisible light image in the same region as a subject region of a visible light image obtained by the subject detection unit 104 is generated, and when the luminance values are within a predetermined range, it is determined that supervisory data can be generated and when the luminance values are outside of the predetermined range, it is determined that supervisory data cannot be generated. Regarding the luminance values, a histogram generated based on the entire image may be used. The supervisory data generation determination unit 105 includes a subject type designation unit (not illustrated) and can determine whether supervisory data for a pre-designated subject can be generated by a subject type for which to generate supervisory data being set by a user operation or a subject type for which to generate supervisory data being selected by a user operation in superimposed display of an invisible light image and a subject detection result, which will be described later in FIG. 5.

When it is determined by the supervisory data generation determination unit 105 that supervisory data can be generated, the supervisory data generation unit 106 generates invisible light image supervisory data based on an invisible light image and a subject detection result of the subject detection unit 104. The supervisory data generation unit 106 includes an image processing unit (not illustrated) and can generate a plurality of pieces of supervisory data from a single invisible light image by executing specific image processing on the invisible light image. The specific image processing includes, for example, at least one of processing for creating bokeh, processing of creating blurring, and processing for correcting luminance.

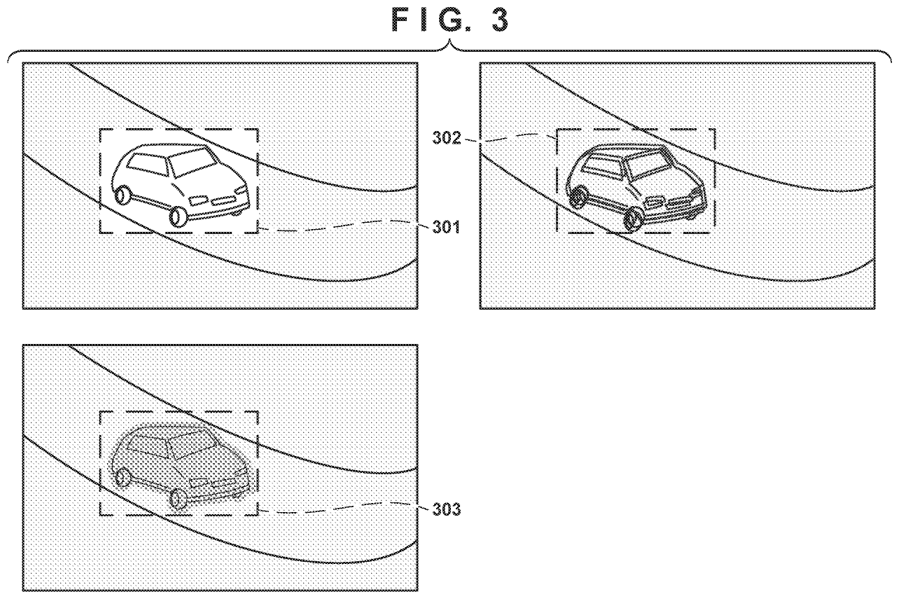

FIG. 3 illustrates processing 301 for correcting luminance, processing 302 for creating blurring, and processing 303 for creating bokeh as examples of specific image processing to be performed on an invisible light image. In the example of FIG. 3, an example in which image processing is performed only on a subject region is illustrated; however, image processing may be performed on the entire image.

The supervisory data storage unit 107 stores invisible light image supervisory data generated by the supervisory data generation unit 106. The learning unit 108 performs learning processing by machine learning on a learning model for subject detection processing of an invisible light image using invisible light image supervisory data stored in the supervisory data storage unit 107. The learning processing of the learning unit 108 is executed with the supervisory data as input data and output data of the learning model for subject detection processing of an invisible light image. A graphics processing unit (GPU) can perform efficient computation by processing more data in parallel processing; therefore, it is useful to perform processing using the GPU when performing learning processing a plurality of times using a learning model, such as in machine learning. In the present embodiment, regarding the learning processing, computation may be performed by the control unit 111, which will be described later, and the GPU cooperating with each other or computation may be performed by the control unit 111 or the GPU alone. In the present embodiment, a configuration is taken such that the image capture apparatus 100 includes the learning unit 108; however, the learning unit 108 may be configured to be separate from the image capture apparatus 100.

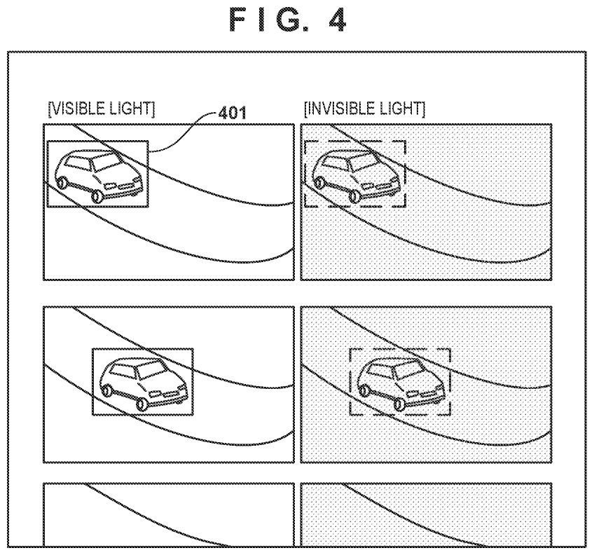

As illustrated in FIG. 4, the display unit 109 displays a subject detection result 401 obtained by the subject detection unit 104 in a superimposed manner on one or both of the visible light image obtained by the first image processing unit 103a and the invisible light image obtained by the second image processing unit 103b. The displayed subject detection result 401 is a rectangular frame surrounding the subject region. As illustrated in FIG. 5, the display unit 109 displays the invisible light image supervisory data obtained by the supervisory data generation unit 106 for preview. In the example of FIG. 5, the class information, the size information, and the position information of the subject are displayed as invisible light image supervisory data 501 in a superimposed manner on the visible light image or the invisible light image for preview. This makes it possible for the user to visually recognize the subject detected in the visible light image in a state in which it is superimposed on the visible light image and the invisible light image as well as confirm the generated supervisory data. In addition, the user can change the class information of the subject, which serves as the supervisory data, and change the determination result as to whether supervisory data can be generated by an operation on the display screen.

The memory 110 includes a non-volatile memory (ROM), a volatile memory (RAM), and the like and stores a control program for controlling the overall operation of the image capture apparatus 100 and various parameters.

The control unit 111 includes a processor (Central Processing Unit: CPU) for controlling the entire operation of the image capture apparatus 100 by executing the program stored in the memory 110.

Next, the invisible light image supervisory data of the present embodiment is generated. Supervisory data generation processing will be described.

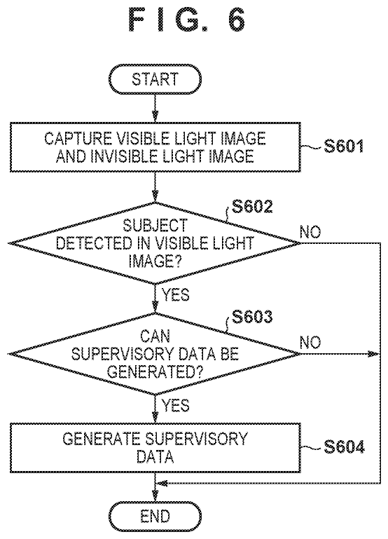

FIG. 6 is a flowchart illustrating processing for generating invisible light image supervisory data the present embodiment.

The processing of FIG. 6 is realized by the control unit 111 of the image capture apparatus 100 illustrated in FIG. 1 controlling respective components by executing the program stored in the memory 110.

In step S601, the control unit 111 generates a visible light image and an invisible light image of the same angle of view by capturing the visible light image and the invisible light image simultaneously or consecutively using the first image capturing unit 102a and the second image capturing unit 102b. Further, the control unit 111 executes predetermined image processing on the visible light image and the invisible light image using the first image processing unit 103a and the second image processing unit 103b.

In step S602, the control unit 111 performs subject detection processing on the visible light image obtained in step S601 using the subject detection unit 104. Then, the control unit 111 determines whether a subject has been detected and advances the processing to step S603 when the control unit 111 determines that a subject has been detected and terminates the processing when the control unit 111 determines that a subject has not been detected.

In step S603, the control unit 111 determines whether invisible light image supervisory data can be generated by the supervisory data generation determination unit 105 based on the subject detection result of step S602 and the invisible light image obtained in step S601. The control unit 111 advances the processing to step S604 when the control unit 111 determines that the supervisory data can be generated and terminates the processing when the control unit 111 determines that the supervisory data cannot be generated.

In step S604, the control unit 111 generates invisible light image supervisory data using the supervisory data generation unit 106 based on the subject detection result of step S602 and the invisible light image obtained in step S601.

As described above, according to the first embodiment, supervisory data to be used for machine learning of a learning model for subject detection of an invisible light image can be efficiently and accurately generated based on an invisible light image and a detection result of a subject in a visible light image. This makes it possible to generate a large amount of supervisory data for machine learning of a learning model for subject detection processing of an invisible light image.

### Second Embodiment

Next, a second embodiment will be described.

In the second embodiment, an example in which a system for which the image capture apparatus 100 of the first embodiment is separated into an image capture apparatus 710 for generating a visible light image and an invisible light image and a supervisory data generation apparatus 720 for generating invisible light image supervisory data is configured will be described.

In the following, parts different from the first embodiment will be mainly described, and description of common parts will be omitted.

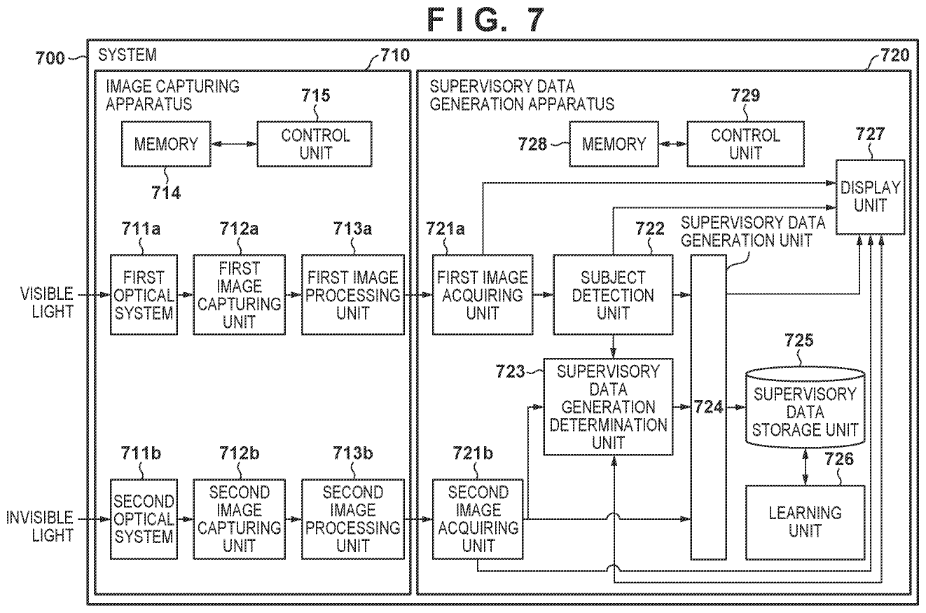

FIG. 7 is a block diagram illustrating a configuration of a system 700 according to the second embodiment.

The system 700 of the second embodiment includes the image capture apparatus 710 and the supervisory data generation apparatus 720.

The image capture apparatus 710 includes a first optical system 711a, a second optical system 711b, a first image capturing unit 712a, a second image capturing unit 712b, a first image processing unit 713a, a second image processing unit 713b, a memory 714, and a control unit 715.

The image capture apparatus 710 is, for example, a monitor camera or a fixed-point camera capable of simultaneously or consecutively capturing a visible light image and an invisible light image of the same angle of view. The image capture apparatus 710 is capable of capturing a visible light image and an invisible light image at a specific timing, continuously or at regular intervals. The first optical system 711a, the second optical system 711b, the first image capturing unit 712a, the second image capturing unit 712b, the first image processing unit 713a, and the second image processing unit 713b are similar to the first optical system 101a, the second optical system 101b, the first image capturing unit 102a the second image capturing unit 102b, the first image processing unit 103a, and the second image processing unit 103b of the first embodiment.

The memory 714 includes a non-volatile memory (ROM), a volatile memory (RAM), and the like and stores a control program for controlling the overall operation of the image capture apparatus 710 and various parameters.

The control unit 715 includes a processor (CPU) for controlling the entire operation of the image capture apparatus 710 by executing the program stored in the memory 714.

The supervisory data generation apparatus 720 includes a first image acquiring unit 721a, a second image acquiring unit 721b, a subject detection unit 722, a supervisory data generation determination unit 723, a supervisory data generation unit 724, a supervisory data storage unit 725, a learning unit 726, a display unit 727, a memory 728, and a control unit 729.

The supervisory data generation apparatus 720 is, for example, a server connected to the image capture apparatus 710 via a network so as to be capable of communication.

The first image acquiring unit 721a acquires a visible light image from the image capture apparatus 710. The second image acquiring unit 721b acquires an invisible light image from the image capture apparatus 710. The visible light image and the invisible light image are images of the same angle of view captured simultaneously or consecutively.

The subject detection unit 722, the supervisory data generation determination unit 723, the supervisory data generation unit 724, the supervisory data storage unit 725, and the learning unit 726 are similar to the subject detection unit 104, the supervisory data generation determination unit 105, the supervisory data generation unit 106, the supervisory data storage unit 107, and the learning unit 108 of the first embodiment.

The display unit 727 displays a subject detection result obtained by the subject detection unit 722 in a superimposed manner on one or both of the visible light image obtained by the first image acquiring unit 721a and the invisible light image obtained by the second image acquiring unit 721b. Display contents are similar to those in FIG. 5 of the first embodiment.

The memory 728 includes a non-volatile memory (ROM), a volatile memory (RAM), and the like and stores a control program for controlling the overall operation of the supervisory data generation apparatus 720 and various parameters.

The control unit 729 includes a processor (CPU) for controlling the entire operation of the supervisory data generation apparatus 720 by executing the program stored in the memory 728.

Next, supervisory data generation processing for generating supervisory data of an invisible light image according to the second embodiment will be described.

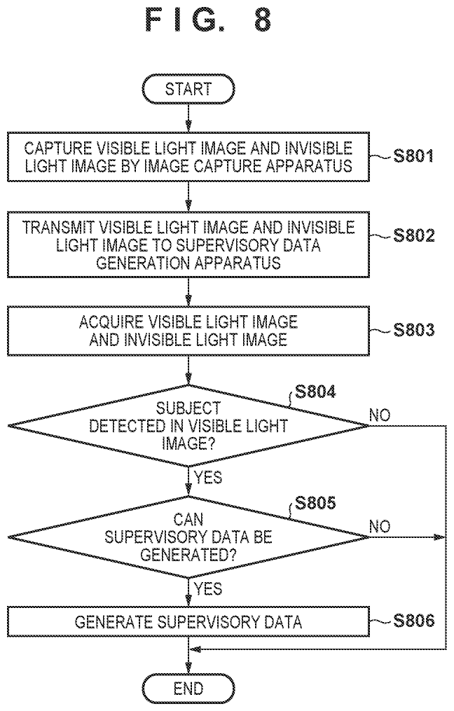

FIG. 8 is a flowchart exemplifying supervisory data generation processing for generating supervisory data of an invisible light image according to the second embodiment.

The processing of FIG. 8 is realized by the control unit 715 of the image capture apparatus 710 and the control unit 729 of the supervisory data generation apparatus 720 of the system 700 illustrated in FIG. 7 controlling respective components. In the processing of FIG. 8, it is assumed that the image capture apparatus 710 and the supervisory data generation apparatus 720 are connected via a network so as to be capable of communication.

In step S801, the control unit 715 of the image capture apparatus 710 generates a visible light image and an invisible light image of the same angle of view by simultaneously or consecutively capturing the visible light image and the invisible light image using the image capture apparatus 710 and executes predetermined image processing on the visible light image and the invisible light image.

In step S802, the control unit 715 of the image capture apparatus 710 transmits the visible light image and the invisible light image obtained in step S801 to the supervisory data generation apparatus 720.

In step S803, the control unit 729 of the supervisory data generation apparatus 720 acquires the visible light image and the invisible light image transmitted from the image capture apparatus 710 in step S802 using the first image acquiring unit 721a and the second image acquiring unit 721b.

In step S804, the control unit 729 of the supervisory data generation apparatus 720 performs subject detection processing on the visible light image obtained in step S803 using the subject detection unit 722. The control unit 729 of the supervisory data generation apparatus 720 determines whether a subject has been detected by the subject detection unit 722 and advances the processing to step S805 when the control unit 111 determines that a subject has been detected and terminates the processing when the control unit 111 determines that a subject has not been detected.

In step S805, the control unit 729 of the supervisory data generation apparatus 720 determines whether invisible light image supervisory data can be generated using the supervisory data generation determination unit 723 and advances the processing to step S806 when the control unit 111 determines that the supervisory data can be generated and terminates the processing when the control unit 111 determines that the supervisory data cannot be generated.

In step S806, the control unit 729 of the supervisory data generation apparatus 720 generates invisible light image supervisory data based the subject detection result obtained in step S804 and the invisible light image acquired in step S803 using the supervisory data generation unit 724.

As described above, according to the second embodiment, by configuring a system in which the image capture apparatus 710 and the supervisory data generation apparatus 720 are separate, it is possible to contribute to versatile and efficient generation of supervisory data, such as setting the supervisory data generation apparatus 720 to be a server.

In the second embodiment, a configuration is taken such that the supervisory data generation apparatus 720 acquires a visible light image and an invisible light image generated by a single image capture apparatus 710; however, the supervisory data generation apparatus 720 may acquire a visible light image and an invisible light image of the same angle of view generated by a plurality of image capture apparatuses. For example, the supervisory data generation apparatus 720 may acquire a visible light image and an invisible light image of the same angle of view generated by a plurality of monitoring cameras or the like installed at different positions.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-179090, filed Nov. 8, 2022 which is hereby incorporated by reference herein in its entirety.

What is claimed is:

1. A data generation apparatus comprising:
a first image acquiring unit that acquires a visible light image;
a second image acquiring unit that acquires an invisible light image;
a subject detection unit that detects a subject in the visible light image; and
a supervisory data generation unit that generates supervisory data to be used in learning of a learning model for subject detection of an invisible light image based on the invisible light image and a subject detection result acquired by the subject detection unit.

2. The apparatus according to claim 1, wherein
the visible light image and the invisible light image are simultaneously or consecutively captured images of the same angle of view.

3. The apparatus according to claim 1, further comprising a supervisory data generation determination unit that determines whether the supervisory data can be generated.

4. The apparatus according to claim 3, wherein
the supervisory data generation determination unit performs the determination based on the invisible light image.

5. The apparatus according to claim 4, wherein
the supervisory data generation determination unit performs the determination based on luminance values of the invisible light image in the same region as a region of the subject detected in the visible light image.

6. The apparatus according to claim 3, wherein
the supervisory data generation determination unit performs the determination based on a predesignated type of subject.

7. The apparatus according to claim 1, wherein
the supervisory data generation unit performs at least one of processing for creating bokeh, processing for creating blurring, and processing for correcting luminance on the invisible light image.

8. The apparatus according to claim 1, further comprising:
a display unit that displays a subject detection result acquired by the subject detection unit and a type of detected subject in a superimposed manner on one or both of the visible light image and the invisible light image.

9. The apparatus according to claim 1, wherein
the first image acquiring unit and the second image acquiring unit acquire a visible light image and an invisible light image of the same angle of view that have been simultaneously or consecutively been captured by an image capture apparatus.

10. The apparatus according to claim 1,
wherein the first image acquiring unit is a first image capturing unit for capturing the visible light image and the second image acquiring unit is a second image capturing unit for capturing the invisible light image, and
wherein the first image capturing unit and the second image capturing unit capture a simultaneously or consecutively captured visible light image and invisible light image of the same angle of view.

11. The apparatus according to claim 1, wherein
the invisible light image is one of a near-infrared image, a far-infrared image, and an ultraviolet image.

12. A method of controlling a data generation apparatus, the method comprising:
acquiring a visible light image and an invisible light image;
detecting a subject in the visible light image; and
generating supervisory data to be used in learning of a learning model for subject detection of an invisible light image based on the invisible light image and the subject detection result.

13. A non-transitory computer-readable storage medium storing a program for causing a computer to function as a data generation apparatus comprising:
a first image acquiring unit that acquires a visible light image;
a second image acquiring unit that acquires an invisible light image;
a subject detection unit that detects a subject in the visible light image; and
a supervisory data generation unit that generates supervisory data to be used in learning of a learning model for subject detection of an invisible light image based on the invisible light image and a subject detection result acquired by the subject detection unit.
